(19) United States
(12) Patent Application Publication
(10) Pub. No.: US 2025/0358630 A1
(43) Pub. Date: Nov. 20, 2025

(54) METHOD AND APPARATUS FOR INTERFERENCE MANAGEMENT USING INTERFERENCE COORDINATION AREAS

(71) Applicants: VIRGIL CIMPU, Ottawa (CA); GARY BOUDREAU, Kanata (CA); STEPHEN RAYMENT, Ottawa (CA)

(72) Inventors: VIRGIL CIMPU, OTTAWA (CA); GARY BOUDREAU, KANATA (CA); STEPHEN RAYMENT, OTTAWA (CA)

(21) Appl. No.: 18/871,870

(22) PCT Filed: Jun. 6, 2023
(86) PCT No.: PCT/IB2023/055835

§ 371 Date: Dec. 5, 2024

Related U.S. Application Data
(60) Provisional application No. 63/349,627, filed on Jun. 7, 2022.

(51) Int. Cl. H04W 16/14

(52) U.S. Cl. CPC H04W 16/14

(57) ABSTRACT

There is provided a method performed by a controlling node. The method comprises: receiving interference information from one of one or more network nodes and one or more operators of the one or more network nodes: determining an interference coordination area (ICA) based on the received interference information, the ICA covering two or more network nodes that are impacted by interference with each other; and determining a coexistence configuration, for the two or more network nodes comprised in the ICA. There is also provided a controlling node (control node) for performing this method.

### RELATED APPLICATIONS

The application claims the benefits of priority of U.S. Provisional Patent Application No. 63/349,627, entitled “Method and Apparatus for Interference Management using Interference Coordination Areas” and filed at the United States Patent and Trademark Office (USPTO) on Jun. 7, 2022.

### TECHNICAL FIELD

This application generally relates to wireless communications and more specifically to interference management using interference coordination areas.

### BACKGROUND

With spectrum being a scare resource, several regulatory authorities around the globe are exploring the introduction of shared spectrum to facilitate re-using spectrum that is scarcely used and enabling new low-cost use cases to drive innovation.

There are several different approaches for shared spectrum, for example Licensed Shared Access (LSA) or Authorized Shared Access (ASA), usually proposing a division of rights of use, based on time of use or geographical constraints between mobile operators and possibly an incumbent user.

One case of shared spectrum is the Citizen's Broadband Radio Service (CBRS) band in the USA, where 3 tiers of users are sharing the spectrum: incumbent users, priority access users (PAL) and general authorized users (GAA). Access to the spectrum is governed by a centralized Spectrum Access System (SAS) that implements a policy management function to protect incumbents as well as implement a tiered access framework. A Citizens Broadband Radio Service Device (CBSD) will first register with the SAS and provide its location information among other registration parameters, and then it will ask the SAS to grant access in a certain channel. Before granting access, the SAS will use information from the Environmental Sensing Capability (ESC) network (or other Incumbent Informing Capability (IIC) portals) to detect incumbent activity in the area where the CBSD operates. The SAS will also use propagation models along with optional measurement reports from the other CBSDs in the same area to predict the level of interference in a certain channel as well as if the channel needs to be protected due to PAL user activity.

The SAS Architecture as described above is depicted in FIG. 1.

Although the Federal Communications Commission (FCC) has specified clear rules on how the incumbent and PAL users need to be protected, sharing the spectrum among GAA users has no specific rules, which can lead to high levels of interference and low network performance. The OnGo Alliance has published several incremental technical specification releases, TS-2001 rel. 2 through rel. 4.1, which aim to provide fair rules for sharing the spectrum among GAA users. WInnForum has also published several technical reports with alternative approaches for CBRS spectrum sharing among GAA users.

The key to the coexistence approach is to strike a balance between strict rules that will help reduce interference and allowing flexibility of network deployments to fulfill different use case requirements, from downlink-heavy mobility and fixed wireless access use cases to uplink-heavy security cameras and industrial use cases. This balance is harder to achieve in the context of an existing eco-system that has focused on Time Division Duplexing (TDD)-type access rather than a sensing-based listen before talk access.

The OnGo Alliance (former CBRS Alliance) has successfully advocated for the use of Third Generation Partnership Project (3GPP) based TDD technology (e.g. Long Term Evolution (LTE) and New Radio (NR)) in the CBRS 3.5 GHz band, and it has augmented the existing FCC

CBRS rules with methods of improving LTE and NR performance in a shared spectrum environment, including:
Localized coexistence solution based on Connected Sets;
GAA Spectrum Orthogonalization (aka Frequency Guidance, aka GAA Spectrum Coordination-GSC) that avoids co-channel interference scenarios with the goal of equal GAA spectrum division between operators;
GAA Frequency Synchronization: all TDD deployments in the band shall be cell phase synchronized and shall have frame timing derived from a common time reference;
GAA TDD Configuration Alignment that helps avoiding User Equipment (UE)-UE (mostly uplink (UL) to downlink (DL)) and eNodeB (eNB)-eNB (mostly DL to UL) interference scenarios in adjacent and alternate channels. For example, FIG. 2 illustrates some TDD interference scenarios.
   a. There are 2 mandatory TDD configurations to be supported by all the CBSDs operating in the CBRS band: TDD Config 2 and TDD Config 1. Other TDD configurations can be used only when the deployment is isolated or when all the operators in the area agree to use a particular configuration.

WInnForum has not been able to converge on a coexistence solution; instead, the WInnForum has published three Technical Reports for GAA Spectrum Coordination summarizing possible coexistence approaches.

SAS administrators have also developed proprietary GAA coexistence solutions where only GAA Spectrum Orthogonalization is covered and it is based on the CBSD group types defined in WInnForum, Spectrum Reuse Group (SRG) and Single Frequency Group (SFG).

PAL coexistence has not been fully addressed, only Part 96 mandatory PAL co-channel protection has been implemented by SASes, and there is no solution for PAL channels impacted by incumbent activation (PAL privileges are simply lost during incumbent activation period).

### SUMMARY

There currently exist certain challenge(s). For the CBRS band, although the OnGo Alliance has published several releases of the Coexistence Technical Specification, it has not been implemented by the SAS Administrators due to the high computational complexity. This has left the CBRS eco-system without a practical coexistence solution and there are currently many reports of interference experienced by CBRS operators using the GAA spectrum.

The other bands with shared spectrum between Public Networks (PN) and Non-Public Networks (NPN) also have a need for coordinating deployments/operations between operators.

Certain aspects of the disclosure and their embodiments may provide solutions to these or other challenges.

For example, this disclosure introduces the concept of an Interference Coordination Area (ICA) where the interference needs to be managed to enable proper network performance. This is essential for ensuring that all the operators using the shared spectrum in the defined geographical area will be able to coexist and meet their intended deployment use case. Coexistence between overlapping network deployments is especially difficult to achieve when the ecosystem is based on TDD-based technology.

For the CBRS band in particular, the ICA will be designated as a GAA Coordination Area (GCA) and the interference will be managed by the Spectrum Access System (SAS) and/or a dedicated entity called the Coexistence Manager (CxM).

Several embodiments detail how the ICAs can be defined and how interference can be managed. The focus is on TDD-based ecosystems although the same concepts could be extended to other technologies.

There is provided a method performed by a controlling node. The method comprises: receiving interference information from one of one or more network nodes and one or more operators of the one or more network nodes; determining an interference coordination area (ICA) based on the received interference information, the ICA covering two or more network nodes that are impacted by interference with each other; and determining a coexistence configuration, for the two or more network nodes comprised in the ICA.

There is also provided a controlling node (or control node) to perform this method.

Furthermore, there is provided a computer program product comprising a computer readable memory storing computer executable instructions thereon that when executed by a computer perform the steps of the method.

Certain embodiments may provide one or more of the following technical advantage(s). The ICAs allow to focus the coexistence coordination effort to the most relevant geographical areas and limit the computational complexity for interference management. Reducing computational complexity is extremely important for coexistence solutions that use a centralized control entity like the SAS or CxM.

### BRIEF DESCRIPTION OF THE DRAWINGS

Exemplary embodiments will be described in more detail with reference to the following figures, in which:

FIG. 1 illustrates an example of a SAS structure.

FIG. 2 illustrates an example of TDD interference scenarios.

FIG. 3 illustrates a flow chart of a method, according to an embodiment.

FIG. 4 shows an example of a communication system, according to an embodiment.

FIG. 5 shows a schematic diagram of a UE, according to an embodiment.

FIG. 6 shows a schematic diagram of a network node, according to an embodiment.

FIG. 7 illustrates a block diagram illustrating a virtualization environment.

### DETAILED DESCRIPTION

Some of the embodiments contemplated herein will now be described more fully with reference to the accompanying drawings. Embodiments are provided by way of example to convey the scope of the subject matter to those skilled in the art.

In the CBRS band, the SAS/CxM has access to the location and properties of all the CBSDs that, along with the use of propagation models, allows it to analyze and predict when CBSDs can interfere with each other. The OnGo Alliance coexistence technical specification requirements state that the Coexistence Manager shall build a connected set of CBSDs and shall use the connected set as an input to the channel assignment algorithm. Two CBSD are deemed to be connected by an edge in the connected set, if there is a coverage overlap between the two CBSDs. In other words, the CBSDs can be represented by nodes in a connected set where the connections (represented by edges) represent the interference between CBSDs. The threshold for defining the CBSD coverage is flexible, but it has been proposed to use a value of −80 dBm/10 MHz. Similar connected sets are built to facilitate TDD configuration alignment.

The algorithm proposed above will trigger high volumes of complex calculations by the SAS/CxM using propagation models to determine the signal and interference levels at different locations. To limit the calculation volume, the ICAs, or the GAA Coordination Areas (GCAs), are introduced. Therefore, the estimation of coverage areas and determination of edges are performed only for the CBSDs which are located within the GCAs. Subsequent calculations of connected sets will only be done for CBSDs within the GCA.

The ICAs can be defined manually by the operators, or they can be automatically identified in the cases/bands where enough information is available. These two cases will be described next. For example, the ICA can be a geographical area, like a polygon on a map.

### Example 1: Operators Define GCAs Based on Areas where they Experience High Level of Interference

When an operator notices that the network performance is impacted in certain area(s), it will perform an initial analysis and gather network performance data that may include field signal measurements. Such measurements can be obtained from the CBSDs, the user equipment devices (EUDs) being served by the CBSDs or by using dedicated signal measurement equipment. If the collected data shows that the root cause of network performance degradation is harmful interference coming from other operators, a GCA can be manually defined around the impacted area and reported to the SAS/CxM through a “back-end” interface. The ICA or GCA can be, for example, the geographical area of the impacted area. The ICA can contain a list of network nodes/CBSDs located within the geographical area defined by the ICA.

The basis of defining harmful interference can be through use of one or more system measurements such as Signal to Interference and Noise Ratio (SINR), Reference Signal Received Power (RSRP) and Reference Signal Received Quality (RSRQ). The SAS/CxM will then apply its coexistence algorithm only for the CBSDs that are located within the GCA, which will result in an attempt to orthogonalize only the spectrum in that area between operators requesting frequency guidance and also potentially aligning TDD configurations between those operators.

In addition to orthogonalizing the spectrum, other approaches to mitigate interference can be applied within the GCA through agreements reached by the operators themselves with the support of the SAS/CxM, such as:
1) Use of spatial diversity through selection of a multi-Transmission Reception Point (TRP) transmission or reception set comprised of one or more CBSDs to optimize SINR for a given network transmission. CBSDs that are part of a multi-TRP transmission will be considered as a single node in the context of calculation of the connected set in the coexistence algorithm. An example of the coexistence algorithm can be found in the OnGo Alliance TS2001.
2) Use of spatial orthogonalization by employing 3D or 2D beamforming to optimize signal reception of the desired transmission. Use of beamforming can be employed in combination with multi-TRP transmissions.
3) Use of spatial orthogonalization by null-steering at one or more of the CBSDs in the GCA to mitigate interference from other co-located interfering CBSDs in the same connected set.

If the CxM determines that, through the use of one or more of the above approaches, the level of harmful interference has been reduced to below a defined acceptable level (for example a level of interference that permits a minimum target transmission rate to be achieved), the edges in the connected set for such CBSDs can be removed.

However, if new network-nodes/CBSDs are deployed within that geographical area (ICA), they will be automatically added to the ICA network nodes list.

### Example 2: SAS/CxM Automatically Builds GCAs Based on Reported Interference Levels

In this example, an operator can report to the SAS/CxM high interference levels for one or multiple CBSDs, or the CBSDs can themselves automatically report interference conditions to the SAS/CxM. The SAS/CxM will use these CBSDs as “seeds” in an algorithm to build a connected set around the impacted CBSDs, using for example each CBSD's interference level, and location information. Once a connected set of CBSDs derived from the “seeds” is identified, a GCA is defined/generated to encapsulate the CBSDs that are part of the connected set for coexistence calculation. Examples of algorithms that could be employed to instantiate this example include unsupervised clustering algorithms such as K-means or density based clustering algorithms such as Density Based Spatial Clustering of Applications with Noise (DBSCAN). Implementation of these algorithms could operate locally, for example in a domain proxy or centrally in a cloud server.

As mentioned above, the ICA can contain a list of network nodes/CBSDs located within the geographical area defined by the ICA. If new network nodes/CBSDs are deployed within that geographical area (ICA), they will be automatically added to the ICA network nodes list.

Once a GCA is created according to the above examples, the SAS/CxM can notify the operators that have CBSDs inside the GCA to negotiate a coexistence solution.

If the impacted operators can reach an off-line agreement on how to manage the interference and improve coexistence, the resulting fixed GAA channel plan and possibly the agreed upon TDD configuration can be enforced by the SAS/CxM within an agreed GCA.

In another example, once a GCA is created, the SAS/CxM can use automated algorithms to find a coexistence solution. For example, the SAS/CxM can use automated algorithms to dynamically achieve frequency or spatial orthogonalization/diversity between operators possibly along with a TDD configuration alignment proposal. The resulting channel guidance and TDD configuration is communicated to the operators' networks. Such automated algorithms may comprise approaches such as deep learning or reinforcement learning implementations which may be instantiated locally for example in a domain proxy or alternatively in a centralized cloud processing unit.

Even though the above description is directed to the CBRS band in the USA, it should be noted that the teachings herein are applicable to other bands (e.g. in other countries), that can be used for, e.g., private network deployments, that are re-using spectrum from public deployments, e.g. in Europe. In some cases, there is no central entity used for coexistence coordination, then such an entity can be introduced or a distributed algorithm can be used.

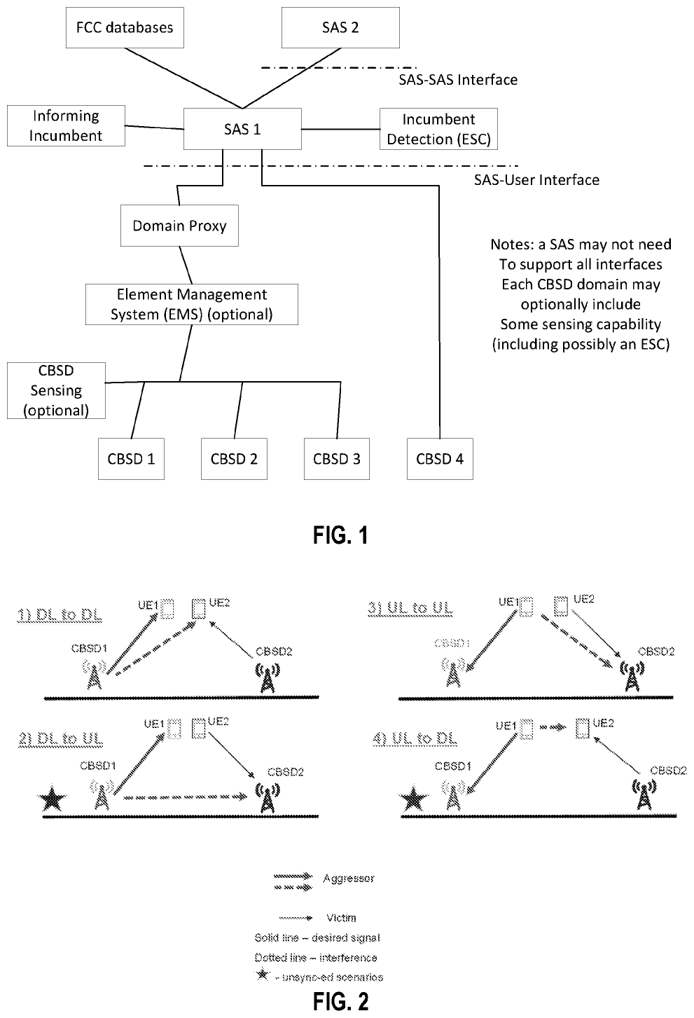

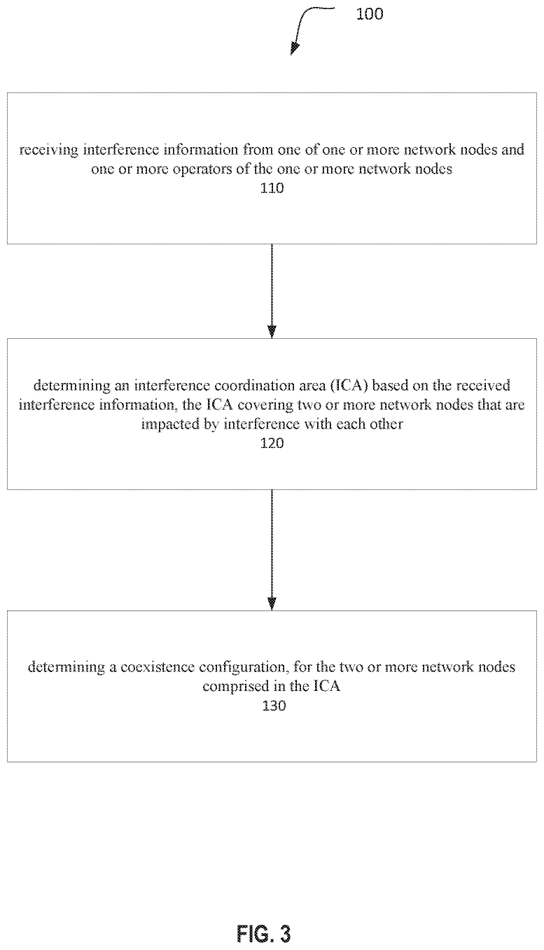

Turning now to FIG. 3, a flow chart of a method 100 for reducing complexity in interference management in a shared spectrum environment will be described. The method 100 can be implemented in a control node, such as the SAS (e.g. SAS 1 of FIG. 1) or the CxM, or a distributed node. Method 100 comprises:
Step 110: receiving interference information from one of one or more network nodes and one or more operators of the one or more network nodes;
Step 120: determining an interference coordination area (ICA) based on the received interference information, the ICA covering two or more network nodes that are impacted by interference with each other; and
Step 130: determining a coexistence configuration for the two or more network nodes comprised in the ICA.

For example, the coexistence configuration can improve the coexistence between the two or more network nodes.

In some examples, receiving the interference information may comprise receiving a geographical area where the one or more network nodes or one or more operators experience interference (or a high level of interference).

In some examples, receiving the interference information may comprise receiving signal measurements.

In some examples, the ICA can be a GAA Coordination Area (GCA).

In some examples, determining the ICA may comprise: building a connected set of network nodes with the two or more networks that interfere with each other as seeds; and generating/defining the ICA that comprises the two or more network nodes of the connected set.

In some examples, building the connected set further may comprise determining an estimation of coverage areas and edges of the two or more network nodes which are located within the ICA.

In some examples, determining the coexistence configuration may comprise orthogonalizing a spectrum between the two or more network nodes comprised in the ICA.

In some examples, determining the coexistence configuration may further comprise determining a Time Division Duplexing (TDD) configuration.

In some examples, determining the coexistence configuration may comprise determining a channel plan for the two or more network nodes.

In some examples, determining the coexistence configuration may further comprise using spatial diversity through selection of a multi-TRP transmission or reception set comprised of the two or more network nodes to optimize Signal to Interference and Noise Ratio (SINR) for a given network transmission.

In some examples, determining the coexistence configuration may further comprise using spatial orthogonalization by employing 3D or 2D beamforming to optimize signal reception of a desired transmission.

In some examples, determining the coexistence configuration may further comprise using spatial orthogonalization by null-steering at the two or more network nodes in the ICA to mitigate interference from other co-located interfering network nodes in a same connected set.

In some examples, determining the coexistence configuration may comprise indicating to the one or more operators of the two or more network nodes comprised in the ICA to negotiate a coexistence configuration for the two or more network nodes.

In some examples, determining the coexistence configuration may comprise using frequency orthogonalization and/or diversity between operators of the two or more network nodes.

In some examples, the ICA can be a geographical area. For example, the ICA can be a polygon (on a map).

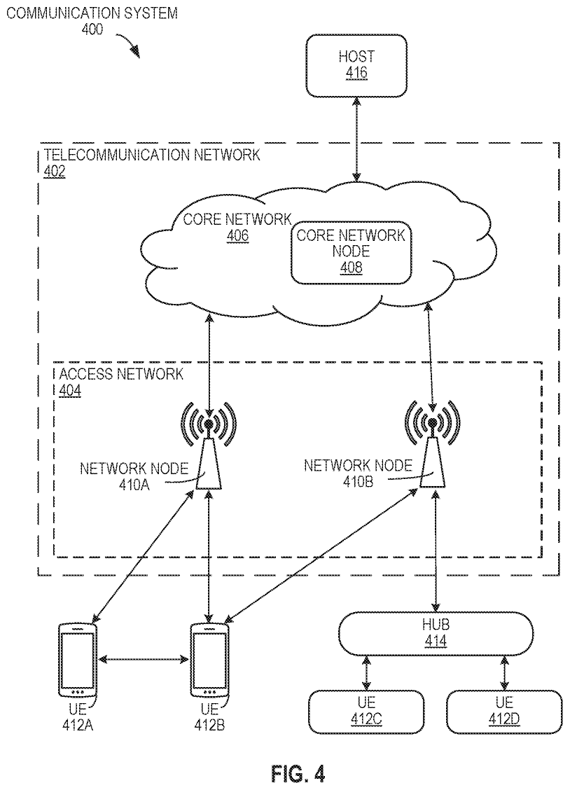

FIG. 4 shows an example of a communication system 4400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3^{rd} Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) NR-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

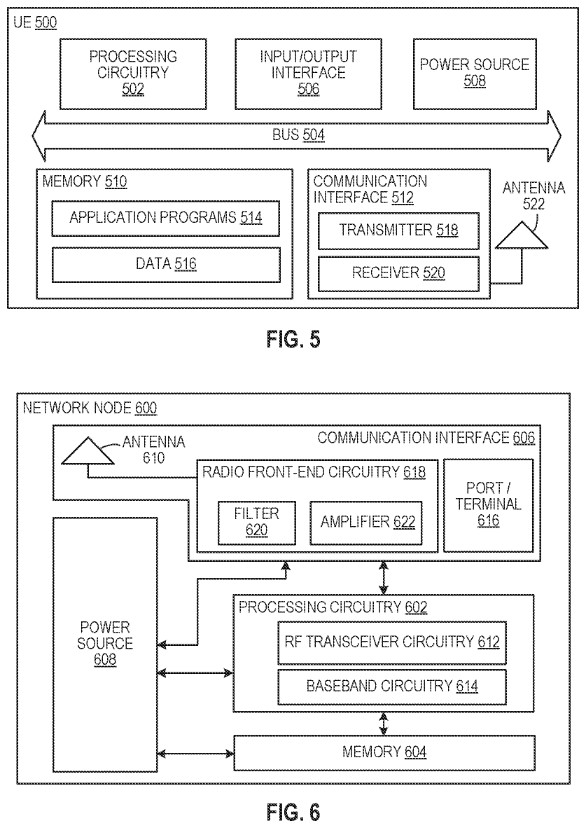

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. An input device may allow a user to capture information into the UE 500. Examples of an input device include a touch-sensitive or presence-sensitive display, a camera (e.g., a digital camera, a digital video camera, a web camera, etc.), a microphone. The presence-sensitive display may include a capacitive or resistive touch sensor to sense input from a user. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE.

As another example, a UE comprises an actuator, a motor, or a switch, related to a communication interface configured to receive wireless input from a network node via a wireless connection. In response to the received wireless input the states of the actuator, the motor, or the switch may change.

A UE, when in the form of an IoT device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a any kind of medical device, etc. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs (NBs), evolved NBs (eNBs) and NR Ns (gNBs), CBSDs). The network node could be also a control node, such as a SAS or CxM, as shown in FIG. 1.

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NBs. In such a scenario, each unique NB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality. For example, the processing circuitry 602 is configured to perform any actions/operations/blocks of method 100 of FIG. 3.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

In case the network node is a SAS, the transceivers and antennas are not necessary. Further, the processing circuitry 602 may be configured to perform any steps of method 100 of FIG. 3.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

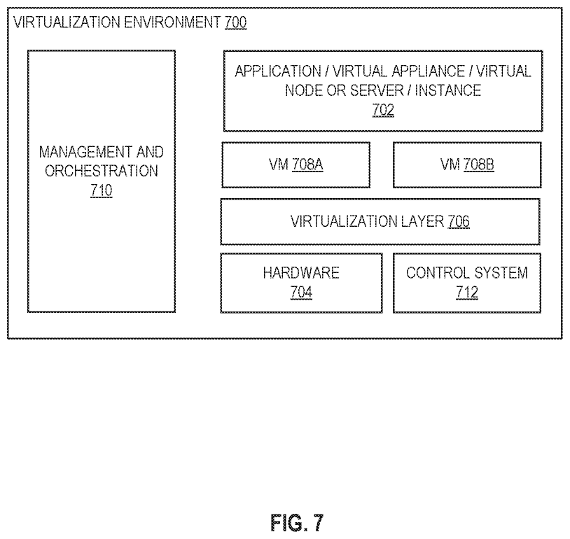

FIG. 7 is a block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 702 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 712 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

1. A method performed by a controlling node, the method comprising:
receiving interference information from one of one or more network nodes and one or more operators of the one or more network nodes;
determining an interference coordination area (ICA) based on the received interference information, the ICA covering two or more network nodes that are impacted by interference with each other; and
determining a coexistence configuration, for the two or more network nodes comprised in the ICA.

2. The method of claim 1, wherein receiving the interference information comprises receiving a geographical area where the one or more network nodes or one or more operators experience interference.

3. The method of claim 1, wherein receiving the interference information comprises receiving signal measurements.

4. The method of claim 1, wherein the ICA is a GAA Coordination Area (GCA).

5. The method of claim 1, wherein determining the ICA comprises:
building a connected set of network nodes with the two or more networks that interfere with each other as seeds; and
generating the ICA that comprises the two or more network nodes of the connected set.

6. The method of claim 5, wherein building the connected set further comprises determining an estimation of coverage areas and edges of the two or more network nodes which are located within the ICA.

7. The method of claim 1, wherein determining the coexistence configuration comprises orthogonalizing a spectrum between the two or more network nodes comprised in the ICA.

8. The method of claim 1, wherein determining the coexistence configuration further comprises determining a Time Division Duplexing (TDD) configuration.

9. The method of claim 1, wherein determining the coexistence configuration comprises determining a channel plan for the two or more network nodes.

10. The method of as claim 1, wherein determining the coexistence configuration further comprises using spatial diversity through selection of a multi-TRP transmission or reception set comprised of the two or more network nodes to optimize Signal to Interference and Noise Ratio (SINR) for a given network transmission.

11. The method of claim 1, wherein determining the coexistence configuration further comprises using spatial orthogonalization by employing 3D or 2D beamforming to optimize signal reception of a desired transmission.

12. The method of claim 1, wherein determining the coexistence configuration further comprises using spatial orthogonalization by null-steering at the two or more network nodes in the ICA to mitigate interference from other co-located interfering network nodes in a same connected set.

13. The method of claim 1, wherein determining the coexistence configuration comprises indicating to the one or more operators of the two or more network nodes comprised in the ICA to negotiate a coexistence configuration for the two or more network nodes.

14. The method of claim 1, wherein determining the coexistence configuration comprises using frequency orthogonalization and/or diversity between operators of the two or more network nodes.

15. The method of claim 1, wherein the ICA is a geographical area.

16. The method of claim 15, wherein the ICA is a polygon.

17. A controlling node comprising network interface and processing circuitry connected thereto, the processing circuitry configured to
receive interference information from one of one or more network nodes and one or more operators of one or more network nodes;
determine an interference coordination area (ICA) based on the received interference information, the ICA covering two or more network nodes that are impacted by interference with each other; and
determine a coexistence configuration, for the two or more network nodes comprised in the ICA.

18. A computer program product comprising a computer readable memory storing computer executable instructions thereon that when executed by a computer perform the steps of:
receiving interference information from one of one or more network nodes and one or more operators of the one or more network nodes;
determining an interference coordination area (ICA) based on the received interference information, the ICA covering two or more network nodes that are impacted by interference with each other; and
determining a coexistence configuration, for the two or more network nodes comprised in the ICA.

19. The controlling node of claim 17, wherein the processing circuitry is configured to receive the interference information by receiving a geographical area where the one or more network nodes or one or more operators experience interference.

20. The controlling node of claim 17, wherein the processing circuitry is configured to receive the interference information by receiving signal measurements.
